(19) United States
(12) Patent Application Publication
(10) Pub. No.: US 2025/0371840 A1
(43) Pub. Date: Dec. 4, 2025

(54) METHOD AND SYSTEM TO PREDICT REFLECTANCE INTENSITY USING HETEROGENEOUS SENSORS

(71) Applicant: Telefonaktiebolaget LM Ericsson (publ), Stockholm (SE)

(72) Inventors: Jonathan Glenn WOMACK, Vero Beach, FL (US); Gregoire PHILLIPS, Sunnyvale, CA (US)

(73) Assignee: Telefonaktiebolaget LM Ericsson (publ), Stockholm (SE)

(21) Appl. No.: 18/867,375

(22) PCT Filed: May 27, 2022
(86) PCT No.: PCT/IB2022/055027

§ 371 Date: Nov. 19, 2024

(51) Int. Cl. G06V 10/60; G06V 10/143; G06V 20/64

(52) U.S. Cl. CPC G06V 10/60; G06V 10/143; G06V 20/64

(57) ABSTRACT

Embodiments include methods, electronic devices, storage medium, and instructions to support prediction of reflectance intensity using heterogenous sensors. In one embodiment, a method comprises: pairing a first tuple with a second tuple based on one or more points in a point cloud for a physical region that are represented by the first and second tuples, the first tuple including a first reflectance intensity and a first wavelength through which the first reflectance intensity is obtained and the second tuple including a second reflectance intensity and a second wavelength through which the second reflectance intensity is obtained. The method continues with generating a prediction function for the point cloud based on the first and second tuples, the prediction function being trained through reflectance intensity spectral distributions of a plurality of materials, and determining a third reflectance intensity based on an input of a third wavelength to the prediction function.

### TECHNICAL FIELD

Embodiments of the invention relate to the field of computing; and more specifically, to predicting reflectance intensity using heterogenous sensors.

### BACKGROUND ART

Using one or more sensors, localization and mapping algorithms may construct or update a map of an environment while keeping track of the sensors' location within it. Such localization and mapping algorithms are used in applications such as extended reality (XR) and autonomous robotics. Localization may acquire a sensor's pose (position and rotation) in a three-dimensional (3D) space, while mapping may acquire and store information about a scene to support future localization. Outside of the computer vision community, astrophysicists, geologists, and biologists have also used the intensity of waves returning to a sensor after reflecting off an object to make inferences about distant objects.

The intensity of waves returning to the sensor after reflection is referred to as reflectance intensity. The reflectance intensity of an object may be measured as the ratio between the emitted radiant energy to an object and the radiant energy reflected from the object as measured by a sensor. The reflectance intensity at all wavelengths (also referred to as frequencies) in the electromagnetic spectrum measured off a material/object are referred to as the spectral signature (also referred to as spectral distribution) of the material/object. The chemical and physical properties of the material/object uniquely determine its spectral signature.

Homogenous sensors refer to multiple sensors of the same type and operate at the same wavelength or wavelength range, and these multiple sensors may be used together to improve the accuracy of localization since multiple datapoints in the same wavelength or wavelength range from these sensors may offset measure errors in individual sensors. In known localization and mapping algorithms, geometric information is used along with the homogenous sensors to improve localization and mapping performance. Yet the reflectance intensity of a wavelength outside of the operating wavelength range of homogenous sensors remains unknowable through these localization and mapping algorithms.

### SUMMARY OF THE INVENTION

Embodiments include methods to predict reflectance intensity using heterogenous sensors. In one embodiment, a method comprises: pairing a first tuple with a second tuple based on one or more points in a point cloud for a physical region that are represented by the first and second tuples, the first tuple including a first reflectance intensity and a first wavelength through which the first reflectance intensity is obtained and the second tuple including a second reflectance intensity and a second wavelength through which the second reflectance intensity is obtained. The method continues with generating a prediction function for the point cloud based on the first and second tuples, the prediction function being trained through reflectance intensity spectral distributions of a plurality of materials, and determining a third reflectance intensity based on an input of a third wavelength to the prediction function.

Embodiments include electronic devices to predict reflectance intensity using heterogenous sensors. In one embodiment, a network device comprises a processor and machine-readable storage medium that provides instructions that, when executed by the processor, cause the network node to perform: pairing a first tuple with a second tuple based on one or more points in a point cloud for a physical region that are represented by the first and second tuples, the first tuple including a first reflectance intensity and a first wavelength through which the first reflectance intensity is obtained and the second tuple including a second reflectance intensity and a second wavelength through which the second reflectance intensity is obtained; generating a prediction function for the point cloud based on the first and second tuples, the prediction function being trained through reflectance intensity spectral distributions of a plurality of materials; and determining a third reflectance intensity based on an input of a third wavelength to the prediction function.

Embodiments include machine-readable storage media to predict reflectance intensity using heterogenous sensors. In one embodiment, a machine-readable storage medium stores instructions which, when executed, are capable of causing an electronic device to perform operations, comprising: pairing a first tuple with a second tuple based on one or more points in a point cloud for a physical region that are represented by the first and second tuples, the first tuple including a first reflectance intensity and a first wavelength through which the first reflectance intensity is obtained and the second tuple including a second reflectance intensity and a second wavelength through which the second reflectance intensity is obtained; generating a prediction function for the point cloud based on the first and second tuples, the prediction function being trained through reflectance intensity spectral distributions of a plurality of materials; and determining a third reflectance intensity based on an input of a third wavelength to the prediction function.

By implementing embodiments as described, the reflectance intensity information across heterogeneous sensors in the electromagnetic spectrum may be reconciled to predict reflectance intensity at a wavelength that is outside of the operating ranges of the heterogeneous sensors.

### BRIEF DESCRIPTION OF THE DRAWINGS

The invention may best be understood by referring to the following description and accompanying drawings that are used to illustrate embodiments of the invention. In the drawings:

FIG. 1 shows spectral signatures and reflectance intensity prediction per some embodiments.

FIG. 2 illustrates a system for reflectance intensity prediction using heterogenous sensors per some embodiments.

FIG. 3 illustrates functional blocks for reflectance intensity prediction using heterogenous sensors per some embodiments.

FIG. 4A shows the pseudo code to return intensity pairs per some embodiments.

FIG. 4B shows the pseudo code to identify pairing for a point in the global point cloud based on k nearest neighbors per some embodiments.

FIG. 4C shows the pseudo code to identify pairing for a point in the global point cloud based on clustering per some embodiments.

FIG. 5 is a first flow diagram illustrating operations for reflectance intensity prediction using heterogenous sensors per some embodiments.

FIG. 6 is a second flow diagram illustrating operations for reflectance intensity prediction using heterogenous sensors per some embodiments.

FIG. 7 is an electronic device that supports prediction of reflectance intensity using heterogenous sensors per some embodiments.

### DETAILED DESCRIPTION

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features, and advantages of the enclosed embodiments will be apparent from the following description.

### Spectral Signature and Reflectance Intensity Prediction

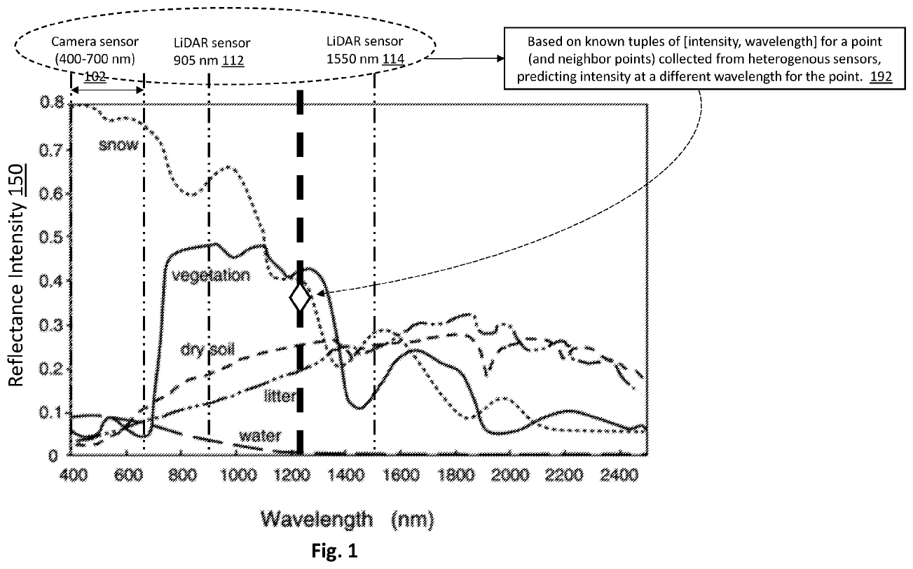

FIG. 1 shows spectral signatures and reflectance intensity prediction per some embodiments. The figure shows a spectrum between 400 to 2,400 nanometers (nm), and the reflectance intensity measurements (at reference 150) of different materials such as snow, vegetation, dry soil, litter, and water. While only the spectral signatures of different materials are shown, different objects have their respective surfaces that reflect off radiant energy, based on which spectral signatures of these objects may be drawn as well. Unless noted otherwise, the terms of “reflectance intensity” and “intensity” are used interchangeably in the Specification.

Determining the spectral signature of an unknown object is immensely useful in many applications. For example, if the spectral signature of the unknown object is obtained, one may compare the obtained spectral signature with the spectral signatures with known materials/objects in a database to identify what the unknown object is made of based on a spectral signature match.

Yet a given sensor, comprising one or more sensing circuits, operates at a particular wavelength or wavelength range (referred to as operating range of the sensor), and it may only measure the reflectance intensity of a given material/object at the sensor's operating range. For example, a red, green, and blue wavelength (RGB) camera sensor (also referred to as a visible imaging sensor) may be a charged-coupled device (CCD), electron-multiplying charge-coupled device (EMCCD), complementary metal-oxide-semiconductor (CMOS), back-illuminated CMOS), and it may operate within a visible light wavelength range between 400 to 700 nm as shown at reference 102. A light detection and ranging (LiDAR) sensor may target a given material/object with a laser and measure the reflectance intensity off the given material/object. A LiDAR sensor operates at one wavelength. In some applications, such as autonomous vehicles and driver assistance, a LiDAR sensor operates at one of 905 nm or 1550 nm as shown at references 112 and 114. The sensors operate at the different operating ranges are referred to as heterogenous sensors, and Camera sensor 102, LiDAR sensor 112, and LiDAR sensor 114 are a group of heterogenous sensors. Other sensors may be included in the group heterogenous sensors, including motion sensors (e.g., a Kinect sensor operating at 780 nm or 850 nm) and LiDAR sensors operating at another wavelength or wavelength range. While not shown in the figure, some heterogenous sensors may share a portion of operating wavelength ranges (overlapping wavelength rages), and a reflectance intensity at a given wavelength may be measured by different types of sensors, in which case the reflectance intensity data at the given wavelength may be provided by multiple heterogenous sensors.

Using a group of heterogenous sensors allows an electronic device to capture the reflectance intensity of an object at several wavelengths or wavelength ranges over which the group of heterogenous sensors operate (the operating range of the heterogenous sensors). Yet a given electronic device may carry only a finite number of sensors, and it thus cannot capture the full spectral signature of the object.

It is desirable to obtain the reflectance intensity at a wavelength (or wavelength range) outside of the operating range of the heterogenous sensors implemented in an electronic device. Embodiments of the invention relate reflectance intensity between heterogenous sensors to predict the reflectance intensity at another wavelength. While examples/embodiments herein describe predicting reflectance intensity at a wavelength, embodiments also apply to predicting reflectance intensity at a wavelength range, based on reflectance intensity data collected by heterogenous sensors operating at a set of wavelengths and/or wavelength ranges. For simplicity of explanation, operating wavelength examples are discussed herein but embodiments of the invention are applicable to collected reflectance intensity data at different operating ranges or at a mix of different operating wavelengths and wavelength ranges to predict reflectance intensity at another wavelength or wavelength range.

Some embodiments predict a reflectance intensity in localization and mapping applications or applications for which a three-dimensional (3D) point cloud is constructed. A 3D point cloud (also referred to as point cloud, point cloud map, or simply map) is a set of data points representing a physical region (also referred to as space). The points of a point cloud may represent a 3D object in the physical region. Each point position may be represented by a set of Cartesian coordinates (x, y, z). The reflectance intensity of a point in a point cloud may be represented by a tuple, which includes a reflectance intensity and a wavelength through which the reflectance intensity is obtained by a sensor. In some embodiments, based on a set of known [intensity, wavelength] tuples for a point (optionally including neighboring points) collected from heterogenous sensors, the reflectance intensity at a different wavelength (the wavelength being outside of the operating wavelength of the heterogenous sensors) may be predicted, as shown at reference 192. Tuple, as used herein, represents a finite ordered list of multiple elements where the element number may be used to refer the tuple type. For example, [intensity, wavelength] is a two-tuple (2-tuple).

For example, an electronic device may perform localization and mapping using LiDAR sensors through two previously mapped physical regions, the first of which was mapped with LiDAR sensors and the second of which was mapped with a camera sensor. The electronic device implements LiDAR sensors but not a camera sensor. The electronic device uses intensity information from LiDAR sensors to aid localization in the first physical region. In the second physical region, without the camera sensor, the electronic device may continue to use intensity information to support localization by converting the LiDAR produced intensities to intensities that would have been produced with the camera sensor, where the predicted intensities are at the camera sensor operating wavelength, which is outside of the operating wavelength of the LiDAR sensors that is currently implemented.

Note that while reflectance intensity is discussed in the examples herein, embodiments of the invention may be used on other reflectance functions as well. For example, a reflectance function may be another measure of (1) emitted radiant energy and (2) the radiant energy reflected based on the emitted radiant energy as measured by a sensor, e.g., instead of a ratio between (1) and (2) as in reflectance intensity, it may compute the second order or higher order values of (1) and (2) to indicate the reflectance characteristics of a material/object. Thus, while embodiments of the invention are explained using examples of predicting reflectance intensity, a value of another reflectance function at a wavelength may be predicted based on the values of reflectance functions at the operating wavelengths of a group of heterogenous sensors.

### Systems for Reflectance Intensity Prediction Using Heterogenous Sensors

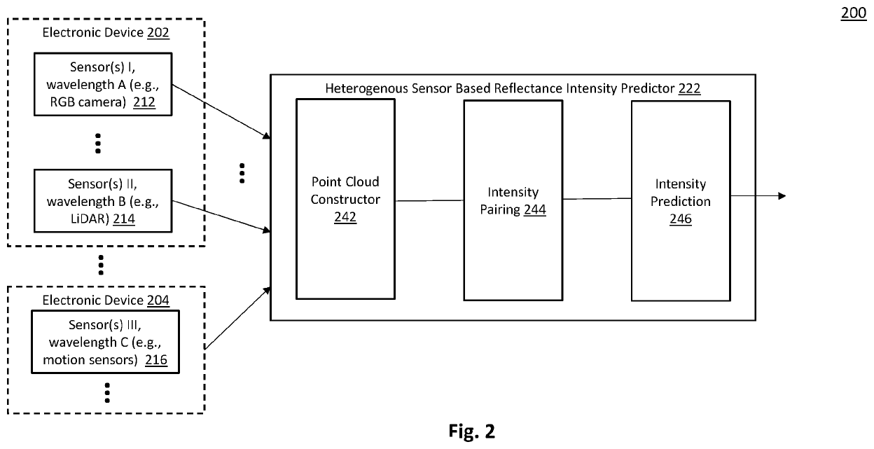

Embodiments of the invention leverage reflectance intensity data collected from heterogenous sensors to build point clouds and predict reflectance intensity at a wavelength outside of the operating ranges of the heterogenous sensors. FIG. 2 illustrates a system for reflectance intensity prediction using heterogenous sensors per some embodiments. A system 200 includes a set of data collection electronic devices (202 to 204) and a heterogenous sensor based reflectance intensity predictor 222. In some embodiments, heterogenous sensor based reflectance intensity predictor 222 and one or more of the set of data collection electronic devices may be integrated into one single electronic device.

The data collection electronic device includes electronic device 202 and electronic device 204 to collect reflectance intensity data from a physical region (e.g., open/urban roads or office buildings). Each electronic device includes one or more sensors. For example, electronic device 202 has a set of sensors (type I), including RGB camera sensor(s), that operates at wavelength A (reference 212) and another set of sensors (type II), including LiDAR sensor(s), that operates at a different wavelength/wavelength range, wavelength B (reference 214), while electronic device 204 has a set of sensors (type III), including motion sensor(s), that operates at wavelength C (reference 216). Each electronic device may include more or less sets of sensors operating at the same or different wavelengths. These sets of sensors, operating at different wavelengths/ranges, form a group of heterogenous sensors.

The reflectance intensity data are collected by the electronic devices and obtained by heterogenous sensor based reflectance intensity predictor 222, which may obtain the reflectance intensity data through a wireless or wireline network. As discussed in further details herein below, an electronic device may implement heterogenous sensor based reflectance intensity predictor 222 that includes a point cloud constructor block 242, an intensity pairing block 244, and an intensity prediction block 246. Each functional block may be implemented by a software/hardware module of the electronic device in some embodiments. Additionally, some or all of these functional blocks may be integrated as a single software/hardware module in some embodiments.

Point cloud constructor block 242 constructs a single 3D point cloud based on reflectance intensity data collected from heterogenous sensors within electronic devices 202 to 204. Intensity pairing block 244 pairs the reflectance intensity data from the heterogenous sensors that represents (1) the same point positions or (2) near the same point positions in the 3D point cloud. Based on the reflectance intensity data pairings, the intensity prediction block 246 predicts the reflectance intensity at another wavelength.

Through embodiments of the invention, reflectance intensity data collected across heterogeneous sensors in the electromagnetic spectrum may be reconciled, and the reflectance intensity data may be aggregated in a spectral library/signature to predict reflectance intensity at another wavelength.

### Exemplary Operations in Reflectance Intensity Prediction

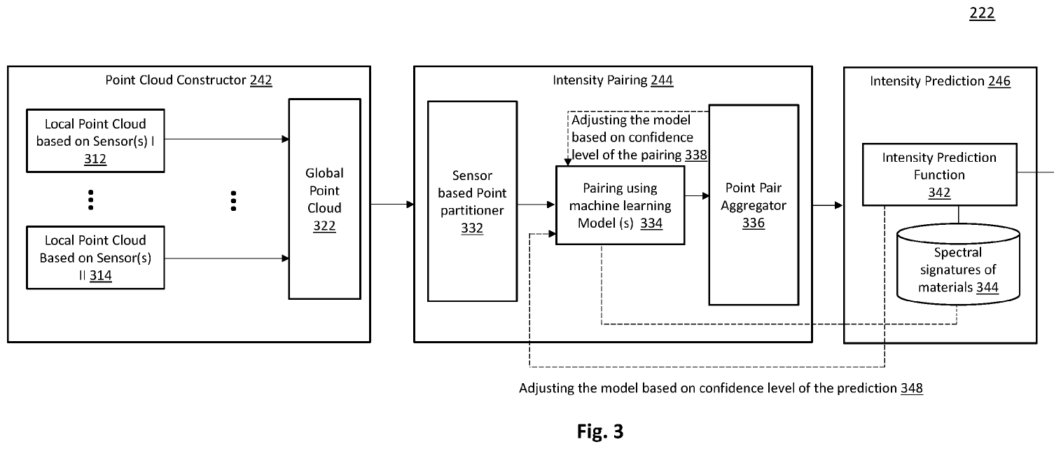

FIG. 3 illustrates functional blocks for reflectance intensity prediction using heterogenous sensors per some embodiments. In some embodiments, heterogenous sensor based reflectance intensity predictor 222 is implemented using the functional blocks shown in FIG. 3, and the operations for reflectance intensity prediction may be divided logically into point cloud construction 242, intensity pairing 244, and intensity prediction 246 with internal functional blocks performing respective functions as explained herein below.

### Point Cloud Construction

At point cloud constructor 242, a set of point clouds 312 to 314, each based on reflectance intensity data collected from one type of sensor, is constructed. For example, a system may have X electronic devices D_1, D_2, . . . , D_X, each with a variable number of sensors S_{W_1}, S_{W_2}, . . . S_{W_N} sensing at M≤N wavelengths W_1, W_2, . . . , W_M (since M≤N, some sensors will share a wavelength). Each point cloud constructed from a sensor type is referred to as a local point cloud (as it is local to the particular sensor type). The local point clouds (LPCs) each may be represented by an array: LPC=[LP_1(x, y, z, intensity), LP_2(x, y, z, intensity), . . . ] for each sensor type.

A global point cloud may be constructed by aligning the local point clouds in the same frame of reference (e.g., a same scene captured by different sensors), returning a global point cloud (GPC)=[GP_1(x, y, z), GP_2(x, y, z), . . . ]. Note that in some embodiments, the intensity values are not used for this initial reconstruction but are included after reconstruction by taking the intensities from local points and including them with their respective global point GP_1(x, y, z)->GP_1(x, y, z, LP_1(intensity), D_1).

In the case of a single electronic device D_1 having a variable number of sensors S_{W_1}, S_{W_2}, . . . S_{W_N} sensing at M≤N wavelengths W_1, W_2, . . . , W_M, the 3D point cloud construction and alignment is fast so long as the relative poses of the sensors are known. Intensity-wavelength tuples can then be constructed directly with reference to their geometric position, and the global point cloud 322 may then be constructed.

### Intensity Pairing

The data from the global point cloud 322 is then provided for intensity pairing at intensity pairing block 244. The ideal sample space of intensity pairs for predicting intensity at one wavelength based on intensity data at other wavelengths would be a spectral signature for each material, from every angle, distance, and environmental condition in a physical region. A dataset covering this sample space does not exist and creating it with spectrometers is unfeasible as they are too expensive and uncommon sensing devices.

A close approximation of this space can be collected with a system localizing many heterogeneous sensors (e.g., system 200). An electronic device (e.g., one implementing heterogenous sensor based reflectance intensity predictor 222) may localize and store intensity information associated with 3D points over time and at scale sample intensity information from the ideal sample space described above. While an electronic device with multiple sensors of various types (e.g., electronic device 202) may improve the system (by providing intensity pairs directly), the system works even with a set of electric devices (e.g., ones like electronic device 204) each with a single, unique sensor.

The intensity pairing may be performed in a variety of ways, as will be discussed herein below in more details. Logically, a sensor based point partitioner 332 partitions the data from the global point cloud based on sensors from which the intensity data are obtained. Then using one or more machine learning models, a point in one partition is paired with other points in one or more other partitions at reference 334. These paired points are deemed to be the same point or neighboring points (also referred to as adjacent points) in the global point cloud, and they may be obtained by sensors operating at different wavelengths. The pairs are aggregated at point pair aggregator 336, which stores the aggregated points based on reflectance intensity obtained from the heterogeneous sensors. Note that the adjacency of the neighboring/adjacent points may be determined based on the physical distance from the central point, e.g., within one millimeter.

In some embodiments, the pairing at reference 334 is performed using one or more unsupervised machine learning models. The pairing is unsupervised as ground truth data is hard to come by in these embodiments. For example, if materials/objects in a physical region are known, the spectral signatures of the materials/objects can be obtained, and there would not be a need to predict reflectance intensity of the materials/objects at another wavelength. In these embodiments, the unsupervised machine learning models are not trained using the data patterns of the pairings from known (tagged) point pairs prior to using them to pair data points collected by heterogenous sensors, but they may be iteratively improved with more applications and through computing confidence levels of the pairings.

Note that each sensor may produce different points in a point cloud for a targeted physical region. In fact, even the same LiDAR sensor passing through the targeted physical region twice may produce different points, because sampling will occur at different times and poses. Because the geometric sampling by different sensors may produce different points, the local point clouds need to be aligned into the single global point cloud, then the intensity pairing handles differences in resolution and spatial distribution of sampling by pairing intensities of points with similar locations and intensities.

Additionally, some materials/objects may reflect at one wavelength, but not another, resulting in “holes” in the 3D point cloud where no intensity or position values are returned for a wavelength. These cases are rare, but the lack of returned wavelength is a signal and could be included in the intensity prediction model as a null class. An example of this are thin sheets of gold, which pass visible light, but reflect infrared. Furthermore, temporal changes make recovering intensity pairs for dynamic portions of the environment more challenging. All these difficulties make implementing machine learning models a better way to pair points in the global point cloud than earlier methods (e.g., ones focusing on pairing based on geometric information) in some embodiments.

In some embodiments, the one or more machine learning models may be adjusted at reference 338, based on the confidence level of the pairing produced as pairing results are obtained at the point pair aggregator 336. Once the confidence level of a point pairing is below a certain threshold, the point pairing process may be repeated to obtain a better pairing for a given point in the point cloud.

### Intensity Prediction

The point pair aggregator 336 stores aggregated paired points, each point aggregation (representing a point and its neighbors) having intensity values and the corresponding wavelengths through which the intensity values are obtained. These values may be used to generate an intensity prediction function at 342 to predict the intensity value at a targeted wavelength.

The input parameters of intensity prediction function are, for a point in a global point cloud, (1) a wavelength and intensity tuple or multiple wavelength intensity tuples in the corresponding sample physical region, and (2) the targeted wavelength for which an intensity value is to be predicted. For example, the input to an intensity prediction function for a wavelength X may be written as (wavelength, intensity, wavelengthX) or (wavelength1, intensity1, wavelength2, intensity2, . . . wavelengthN, intensityN, wavelengthX), corresponding to the two sets of input, one being the known one or more wavelength and intensity tuples, and the other the targeted wavelength.

Given a high enough amount of reflectance data collected in detecting a targeted physical region, these inputs can be used to estimate the spectral signature of any material/object (may be referred to as estimated or pseudo spectral signature of the material/object) in the targeted physical region by generating the intensity prediction function 342. The semantic classes in many computer vision tasks (segmentation, object detection, classification) fall under “thing” or “stuff” categories, being specified by well-defined shapes and amorphous shapes, respectively. Similarly, a material/object is specified by well-defined apparent spectral properties that result from an area with uniform chemical composition and physical form.

Pre-processing the input data such as wavelengths and intensities may be necessary in some embodiments, depending on the type of electronic devices (e.g., electronic devices 202 and 204) using the system (e.g., system 200). Some electronic devices implement sensors such as RGB cameras that have intensity values that do not correspond directly to a single wavelength and require additional steps to estimate wavelength for recorded intensities. Having different sensor types operating at the same wavelength can result in different intensities for the same material, which can be addressed by normalizing or finding a common representation for intensities across different sensors at the same wavelength.

The output of the intensity prediction function is predicted reflectance intensity at a targeted wavelength. Given the wavelengths and intensity values of the material/objects captured in the inputs, the output feature in any model will be a single intensity value at the targeted wavelength X. With an output of this form, an estimate of the spectral signature of a material/object can be formed by repeating sensor input while changing wavelength X to values across the electromagnetic spectrum.

The intensity prediction function is trained under a machine learning model in some embodiments. The intensity prediction function may make its prediction based on reflectance intensity spectral signatures (reflectance intensity spectral distributions) of materials (and/or objects made of the materials) in a database 344. The reflectance intensity spectral distributions of possible/expected materials/objects in a physical region are often known. For example, when the physical region is an urban road, objects such as street signs, waste containers, and traffic lights are expected, and their reflectance intensity as measured by different sensors are known and they can be used to construct (1) the reflectance intensity spectral distributions of materials that are used to build these objects, and/or (2) the reflectance intensity spectral distribution of these objects themselves.

To perform intensity prediction, the predicted intensity may be compared with ground truth data of the material/object in a known (tagged) physical region, where the ground truth data include the sensor data (wavelength and reflectance intensity) and the reflectance intensity measured in a known spatial position (e.g., the ground truth data is obtained at the known spatial position in the known physical region). Statistics methods may be used to implement the machine learning model. For example, an ordinary least squares (OLS) regression model may be used to train intensity prediction function 342. In some embodiments, the prediction result of intensity prediction function 342 may be produced with a confidence score indicating the confidence level of the prediction. When the confidence score is below a certain threshold, the prediction function can be executed again until the produced prediction of the intensity value has a confidence level over the threshold. Additionally, the confidence score may be used to adjust the machine learning model(s) 334 in some embodiments as shown at reference 348. Such feedback allows a better coordination between the point pairing and intensity prediction.

The predicted intensity at the targeted wavelength from the intensity prediction 246 may then be used to build a pseudo spectral signature of the corresponding point in the global point cloud, the corresponding point representing a spot/position in the corresponding physical region. The predicted intensity may be used in localization and mapping.

Note that the most accurate pairings will be obtained from a single electronic device (e.g., electronic device 202) with heterogeneous sensors, rather than the pairings obtained by matching intensities from separate devices (e.g., multiple electronic devices like electronic device 204). This is because in the single device, multi-sensor case, the locations of heterogeneous intensities, which are used for pairing, are more precisely aligned with known, relative positions and angles of sensors on the device. In localization and mapping, pairing intensities sensed from heterogeneous sensors from different electronic devices requires localizing each electronic device, which introduces error in the locations of intensity measurements and creates less precise pairings. As the intensity prediction function improves (through more single electronic device multi-sensor sensing and more indirect pairs as the initial point cloud is used), the global point cloud can be reconstructed again using newly inferred intensities (better intensity predictions, better matches across sensors, more accurate map). The updated global point cloud, then provides more precise intensity pairings.

In the earlier example about localization and mapping in two physical regions, the point clouds about these regions may have been mapped with a first set of sensors that operate at certain wavelengths. Later an electronic device with a second set of sensors that operate at different wavelengths may be deployed for localization and mapping to update the point clouds. By implementing an intensity prediction system (such as system 200), the electronic device may predict the intensity values that would have been produced using the first set of sensors, based on the intensity values measured by the second set of sensors. The point clouds may then be successfully updated, even though the different set of sensors are used in the update process.

Additionally, the predicted intensity and/or the corresponding pseudo spectral signature may be used to refine the global point cloud. The refined global point cloud can then be used to enhance future applications on the global point cloud. For example, the “holes” in the 3D point cloud may be plugged using the predicted intensity.

The prediction of intensity in embodiments of the invention thus provides flexibility in applications such as localization and mapping.

### Intensity Pairing Examples

As discussed herein above, intensity pairing sorts through intensity data collected by heterogenous sensors and provides the input to the intensity prediction function. One or more machine learning models may be used to pair the intensity data, and several pairing approaches are explained in more details herein below.

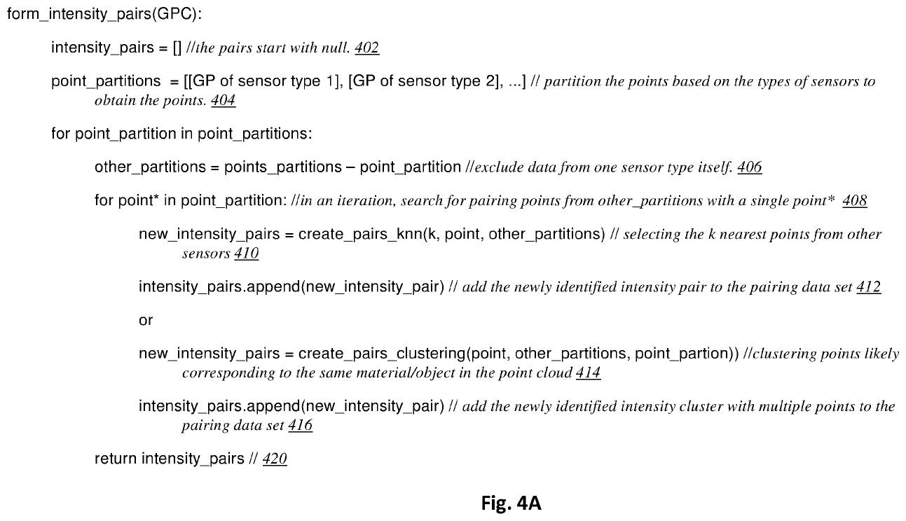

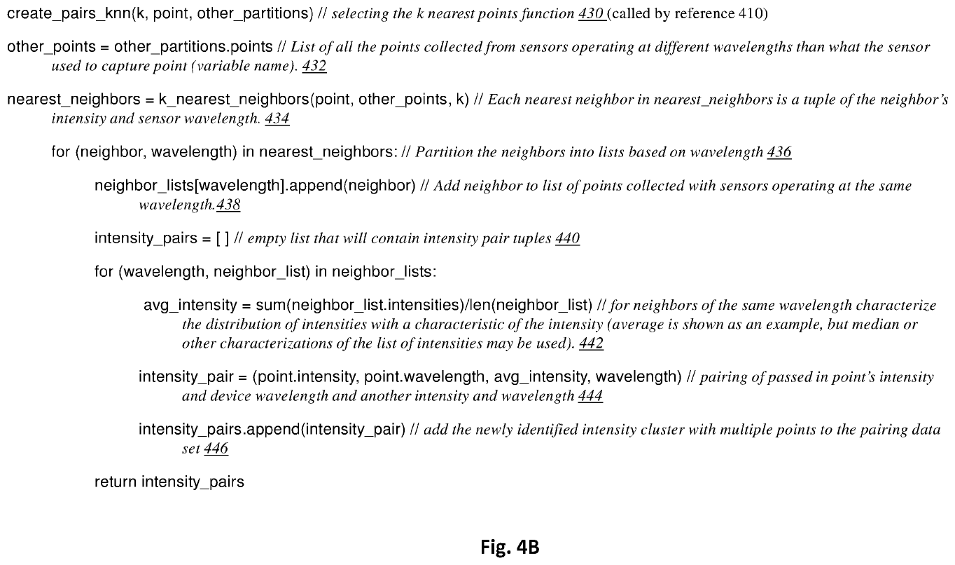

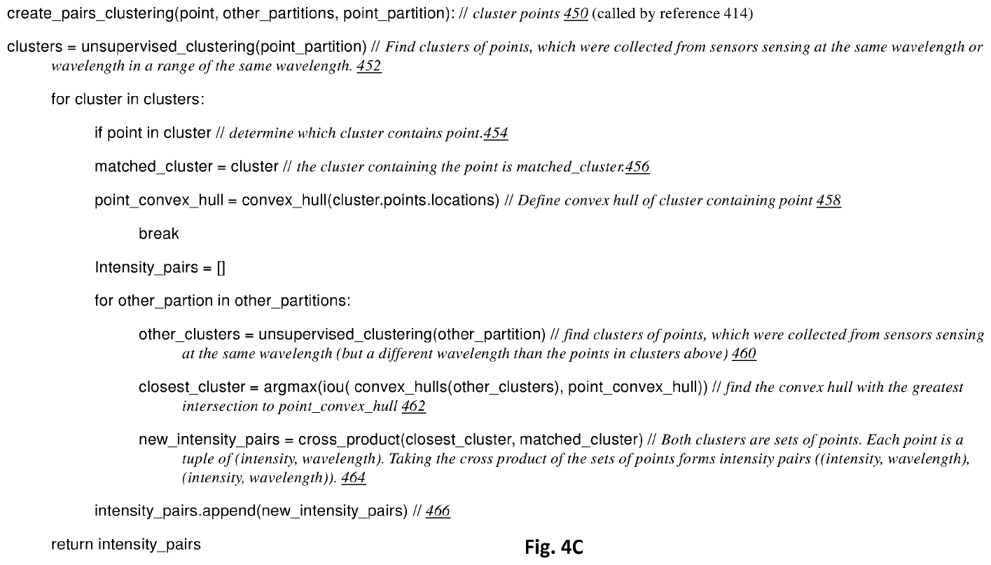

With samples of intensity captured in the same frame of reference (e.g., a same scene captured by difference sensors), intensity pairs are formed based on points positions in the global point cloud, GPC=[GP_1(x, y, z, intensity, device), GP_2(x, y, z, intensity, device), . . . ]. The pairing may be performed in operations in the pseudo code shown in FIGS. 4A to 4C.

FIG. 4A shows the pseudo code to return intensity pairs per some embodiments, and it invokes function create_pairs_knn ( ) in FIG. 4B or function create_pairs_clustering ( ) in FIG. 4C. The aim of the pseudo code is to form intensity pairs for a given frame of reference. It starts at reference 402, where no pairs are in intensity pairs array. Then at reference 404, the sample points, GPC=[GP_1(x, y, z, intensity, device), GP_2(x, y, z, intensity, device), . . . ], are partitioned in a plurality of point partitions. Each partition includes data from one type of sensor. Then each partition goes through a loop to identify points to pair in the other partitions as shown at reference 406.

For a given partition, each point (point*, which is one point within the points in the point partition) is processed through a loop to identify points in the other partitions to pair with, as shown at reference 408. The pairing may be identified through the K nearest neighbors (KNN) from other sensors as shown at reference 410. Alternatively, the pairing may be identified through clustering, which gathers points likely corresponding to the same material/object in the point cloud at 414. In both cases, the newly identified pairing will be appended to intensity_pairs, which is returned after executing the pseudo code.

Other than the KNN and clustering, other methods of pairing may be based on prior known information about materials in the physical region (material priors), segmentation, and interior points, and these methods are explained in more details herein below.

### K Nearest Neighbors (KNN)

This method pairs a point with some intensity and wavelength with another intensity and wavelength based on a k-nearest neighbors in the global point cloud. FIG. 4B shows the pseudo code to identify pairing for a point in the global point cloud based on k nearest neighbors per some embodiments.

The pseudo code is for create_pairs_knn ( ), which as explained at reference 430, may be used to select the k nearest points in input other_partitions of an input point in the global point cloud as shown in FIG. 4A (see reference 410). At reference 432, the values of other_points are included in an array, which includes all the points collected from sensors operating at different wavelengths than what the sensor used to capture the point (which is given to create_pairs_knn function as the input) at reference 432.

Then the k nearest neighbors are stored in an array of nearest_neighbors, where each nearest neighbor is a tuple of the neighbor's intensity and sensor wavelength as shown at reference 434.

Then the neighbors are partitioned into lists based on wavelength at reference 436, and neighbors collected with sensors operating at the same wavelength is included in the same list, thus the neighbor_lists are values grouped by the different wavelength at 438.

At reference 440, the intensity_pairs are null initially, and the intensity_pairs are populated by looping through the different wavelengths, where for each wavelength, a characteristic of the included neighbors per wavelength is determined. While the example at reference 442 showing a calculation of average intensity value, the characteristic of the neighbors can be median or another feature that characterizes the list of intensities at the wavelength, as shown at reference 442. The characteristic of the neighbors then becomes a threshold value for which the neighbors of the point are judged against. The neighbors at the wavelength that pass the threshold are then included in the intensity_pair for the wavelength at reference 444. The neighbors for the wavelength are then included in the intensity_pairs at 446, until all the wavelengths included in (wavelength, neighbor_list) are examined.

### Clustering

Alternatively, it is observed that points that are close in space with similar intensity values likely come from the same material/object. Unsupervised clustering can be utilized to form clusters of points collected from a single wavelength (or small range of wavelengths) that likely come from the same material. Convex hulls of clusters from different wavelengths that intersect can then be used to form intensity pairs. A convex hull (also referred to as convex envelope or convex closure) of a material/object is the smallest convex set that contains it. The convex hull may be defined either as the intersection of all convex sets containing a given subset of a space, or equivalently as the set of all convex combinations of points in the subset. Each convex hull of the material/object in the global point cloud may be construed from data collected from a single sensor.

FIG. 4C shows the pseudo code to identify pairing for a point in the global point cloud based on clustering per some embodiments. The pseudo code is for create_pairs_clustering( ), which as explained at reference 450, may be used to select cluster points of other_partitions pairing to an input point of a point_partition in the global point cloud as shown in FIG. 4A (see reference 414).

At reference 452, the function of unsupervised_clustering is to find clusters of points, which from sensors sensing at the same wavelength. Then for each cluster in the resulting clusters, whether the input point is in the cluster is determined at reference 454. The cluster having the input point is identified as matched_cluster at reference 456. The convex hull of the cluster containing the point is identified at reference 458 as point_convex_hull. The loop is then exit.

Then for each other partition in the other partitions, clusters of points are found, and the clusters of points were collected from sensors sensing at the same wavelength, yet the wavelength is a different wavelength than the points in clusters above, as shown at reference 460.

Then the convex hull with the greatest intersection to point_convex_hull is found at reference 462 as the closest cluster. The convex hull of the closest cluster maximizes the intersections of the convex hull containing the point from 456.

Both matched cluster and closest cluster are sets of point, and each point is a tuple of (intensity, wavelength). Taking the cross product of the sets of points, where the cross product is the binary operation on two vectors that results in a vector perpendicular to both, forms the intensity pairs ((intensity, wavelength), (intensity, wavelength)) at reference 464. The new pair of the two tuples is then included in the intensity_pairs at 446. All the partitions in the other partitions examined to identify the pairings at different wavelengths.

### Material Priors

In some cases, prior information on the distribution of volumes of space in a physical region occupied by a uniform material may be known or possibly estimated This information may be domain specific. For example, a translation of one millimeter along any direction of most household objects won't result in a change in material.

Like a sliding window on time series data or a convolution on an image, a sliding sphere (with radius one millimeter for the above example) can be used to form sets of points such that each point is in the sphere and each set of points contains all the points collected from sensors sensing at the same wavelength. Intensity pairs can then be formed by taking the cross product of sets of points from the same sphere.

Spheres are not guaranteed to contain points from the same material. However, appropriately sized spheres are unlikely to contain material boundaries, mitigating the effects of this problem. Thus, the pairing of points may be based on the proximity of points when the points are deemed (or known) to be corresponding to the same material.

### Segmentation

Segmentation is used in computer vision applications such as localization and mapping. Two types of image segmentation are semantic segmentation and instance segmentation. In semantic segmentation, objects shown in an image are grouped based on defined categories. For example, when the image is showing a physical region of an urban road, the image may be segmented by categories such as “pedestrians,” “bikes,” “vehicles,” and “sidewalks.” Instance segmentation may be viewed as a refined version of semantic segmentation, and categories like “vehicles” are split into “cars,” “motorcycles,” “buses,” and so on; instance segmentation thus detects the instances of each category. A semantic category, particularly the same instance of the semantic category shares the same composition, so this prior information can be used to produce pairings directly, or act as an additional feature during KNN and clustering based pairing.

Segmentation models exist for common sensors such as RGB camera sensors and LiDAR sensors that sense in the electromagnetic spectrum. Then a trained segmentation model may be applied for these common sensors. To apply instance segmentation, each instance has a corresponding convex hull (defined by the instance points). For any two intersecting convex hulls, intensity pairs can be formed by choosing any two points such that the pair has a point from each convex hull. For semantic segmentation, the same procedure as instance segmentation is followed, except the convex hull is defined by the segment, rather than the instance, and the pair from the intersecting convex hulls may then be identified. Because that instance segmentation further refines the categories in the semantic segmentation, the resulting pairs may be more likely from the same material/object thus more accurate.

### Interior Points

For objects that are uniform in material, there should be no intensity measurements from the surface of the object that are significantly different than the rest. If there are significantly different measurements inside an area defined by points of similar intensity, then it is likely those points of similar intensity do not define a single object, but multiple. The corresponding convex hull can then be decomposed into smaller convex hulls representing the multiple objects.

This is based on observation that most objects are somewhat uniform in material and rapidly changing material over small distances is uncommon. Convex hulls may be defined by the sets of points with similar intensities collected from sensors operating at the same or similar wavelengths. If there were no intersections between these convex hulls, one could reasonably assume that each hull corresponds to a single object. In this case, intensity pairs can be formed by taking the cross product of point sets corresponding to any two convex hulls that (1) intersect and (2) come from sensors operating at different wavelengths.

Otherwise, the convex hulls (defined by the sets of points with similar intensities collected from sensors operating at the same or similar wavelengths) intersect and it is likely that each hull corresponds to multiple objects. These convex hulls can then be decomposed into smaller convex hulls such that the hulls are either completely inside of another convex hull or have no intersection with another convex hull. This is done by removing all the edges incident to a vertex (V_interior) of one convex hull that resides inside another convex hull and adding edges between the vertices incident to V_interior. Performing this operation repeatedly over all vertices that reside inside another convex hull will produce convex hulls such that the convex hulls are either completely inside of another convex hull or have no intersection with another convex hull. Then the intensity pairs can again be formed by taking the cross product of point sets corresponding to any two convex hulls that (1) intersect and (2) come from sensors operating at different wavelengths.

While these five point pairing approaches are explained separately, they may be used together in some embodiments. For example, the segmentation process may be used along with pairing based on either KNN or clustering to expedite the pairing process (e.g., performing KNN or clustering within a semantic/instance segment). Additionally, prior information on the distribution of volumes of space in a physical region utilized in the material priors approach may be used to confirm whether the point pairing obtained through other approaches are feasible/valid by comparing the point pairing through other approaches with the known uniform materials in the physical region. The comparison can compute a confidence level of the point pairing through the other approaches so that the clearly erroneous pairing based on the known uniform materials can be flagged and removed. Similarly, the intensity pairs identified in either KNN or clustering approaches may be confirmed through the interior points or vice versa.

### Operational Flows per Some Embodiments

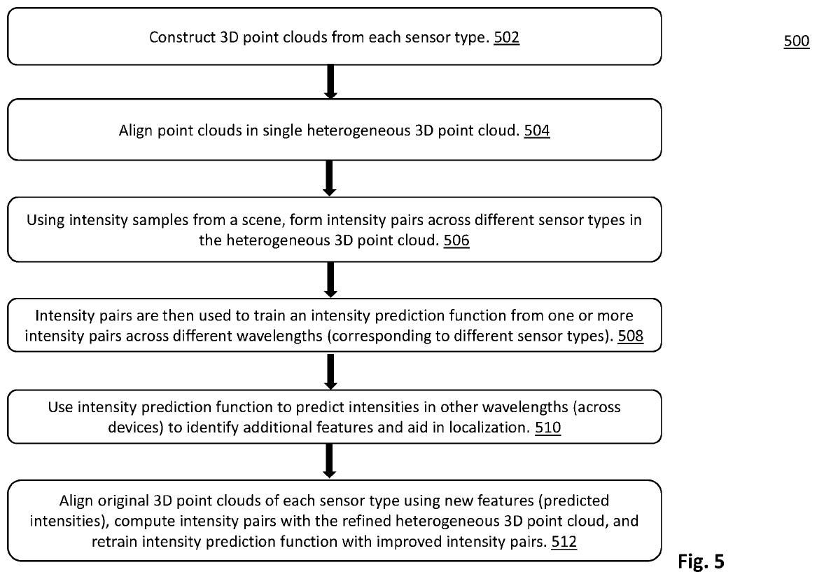

FIG. 5 is a first flow diagram illustrating operations for reflectance intensity prediction using heterogenous sensors per some embodiments. The operations of method 500 may be performed by an electronic device implementing heterogenous sensor based reflectance intensity predictor 222 in some embodiments.

At reference 502, a plurality of 3D point clouds are constructed, one for each sensor type. At reference 504, the plurality of point clouds are aligned in a single heterogenous 3D point cloud (e.g., the global point cloud (GPC) discussed herein). Then at reference 506, using intensity samples from a scene, intensity pairs are formed across different sensor types in the single heterogenous 3D point cloud. The intensity pairs are then used to train an intensity prediction function from one or more intensity pairs across different wavelengths (corresponding to different sensor types) at reference 508. The intensity prediction function is trained under a machine learning model in some embodiments as discussed herein.

At reference 510, the intensity prediction function is used to predict intensities in other wavelengths (across different sensor types) to identify additional features and aid in localization. At reference 512, the original 3D point clouds of each sensor type are aligned using new features (predicted intensities), intensity pairs are computed with the refined heterogeneous 3D point cloud, and the intensity prediction function is retrained with improved intensity pairs.

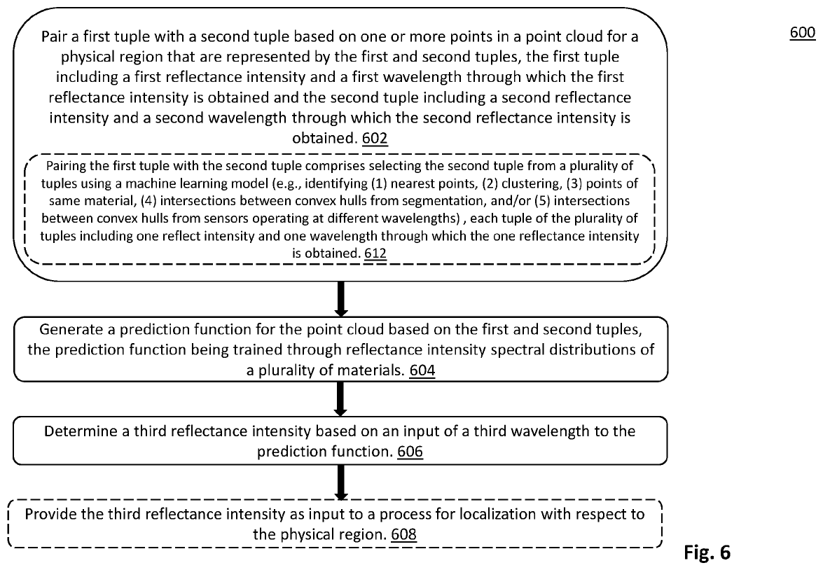

FIG. 6 is a second flow diagram illustrating operations for reflectance intensity prediction using heterogenous sensors per some embodiments. The operations of method 600 may be again performed by an electronic device implementing heterogenous sensor based reflectance intensity predictor 222 in some embodiments.

At reference 602, the electronic device pairs a first tuple with a second tuple based on one or more points in a point cloud for a physical region that are represented by the first and second tuples, the first tuple including a first reflectance intensity and a first wavelength through which the first reflectance intensity is obtained and the second tuple including a second reflectance intensity and a second wavelength through which the second reflectance intensity is obtained. As discussed herein above, each of the first and second tuples may be in the form of [wavelength, intensity].

At reference 604, a prediction function is generated for the point cloud based on the first and second tuples, the prediction function being trained through reflectance intensity spectral distributions of a plurality of materials. The plurality of materials are possible/expected materials that are in the physical region. The generation and training of the prediction function (e.g., intensity prediction function 342) are discussed herein above.

At reference 606, a third reflectance intensity is determined based on an input of a third wavelength to the prediction function. The determination is a prediction of the third reflectance intensity as discussed herein above. In some embodiments, one or more additional reflectance intensities are determined based on an input of one or more additional wavelengths to the prediction function (e.g., for determining reflectance intensities over the spectrum). The iterative determinations of reflectance intensity at different wavelengths may be used to estimate the spectral signature of the materials and objects in the physical region.

Optionally at reference 608, the determined third reflectance intensity is provided as input to a process for localization with respect to the physical region. For example, the determined third reflectance intensity may be used to refine the point cloud (a global point cloud) as discussed herein above.

In some embodiments, the first tuple is from data collected by a first sensor that operates at the first wavelength and the second tuple is from data by a second sensor that operates at the second wavelength, wherein the point cloud for the physical region is generated based on a plurality of point clouds that include a first point cloud generated from the data collected by the first sensor and a second point cloud generated from the data collected by the second sensor. The plurality of point clouds comprises local point clouds discussed herein above and they are aligned to form the point cloud for the physical region.

In some embodiments, each of the first and second tuples further includes one three-dimensional coordinates of the one or more points, and a value based on one sensor through which corresponding data is collected. For example, a tuple may be in the form of (x, y, z, LP_1(intensity), ID), where the identifier (ID) identifies either a sensor through which the intensity value is obtained or the electronic device that implements the sensor.

In some embodiments, the one or more points represented by the first and second tuples corresponds to a same point position in the point cloud, and the first and second wavelengths are different wavelengths.

In some embodiments, the one or more points represented by the first and second tuples are adjacent in the point cloud for the physical region and the one or more points corresponding to a same material in the physical region.

In some embodiments, pairing the first tuple with the second tuple comprises selecting the second tuple from a plurality of tuples using a machine learning model, each tuple of the plurality of tuples including one reflect intensity and one wavelength through which the one reflectance intensity is obtained as shown at reference 612. The machine learning model is used to identify (1) nearest points, (2) clustering, (3) points of the same materials, (4) intersections between convex hulls from segmentation, or (5) intersections between convex hulls from sensors operating at different wavelengths as shown at reference 612.

(1) In some embodiments, the second tuple is selected based on the machine learning model identifying a plurality of nearest points in the point cloud to a corresponding point represented by the first tuple, and the second tuple representing one of the plurality of nearest points. The identification through the plurality of nearest points in the point cloud is explained relating to the KNN method herein above.

(2) In some embodiments, the second tuple is selected based on the machine learning model identifying a plurality of points that form a convex hull closest to a convex hull containing a corresponding point represented by the first tuple, and the second tuple representing one of the plurality of points. This identification is explained relating to the clustering method herein above.

(3) In some embodiments, the second tuple is selected based on the machine learning model identifying a plurality of points that are determined to correspond to a same material as the first tuple, and the second tuple representing one of the plurality of points. This identification is explained relating to the material priors method herein above.

(4) In some embodiments, the second tuple is selected based on the machine learning model identifying a plurality of points that form a first convex hull that intersects with a second convex hull including a corresponding point represented by the first tuple, the second tuple representing one of the plurality of points, and wherein the first and second convex hulls are formed through segmentation. This identification is explained relating to the segmentation method herein above.

(5) In some embodiments, the second tuple is selected based on the machine learning model identifying a plurality of points that form a first convex hull that intersects with a second convex hull including a corresponding point represented by the first tuple, the second tuple representing one of the plurality of points, and wherein the first and second convex hulls are formed by a first and second sensor operating at different wavelengths. This identification is explained relating to the interior points method herein above.

### Electronic Devices Implementing Embodiments of the Invention

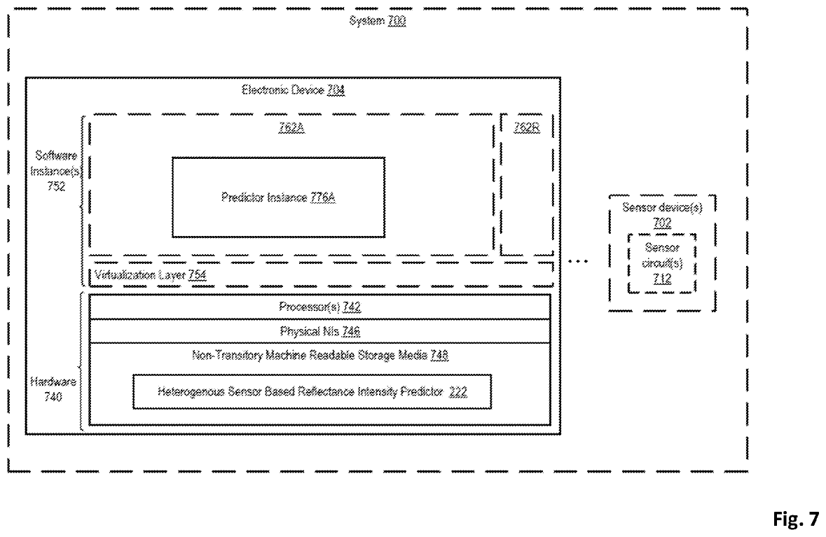

FIG. 7 shows a system that supports prediction of reflectance intensity using heterogenous sensors per some embodiments. System 700 includes an electronic device 704 to predict reflectance intensity using heterogenous sensors. In some embodiments, electronic device 704 includes a set of sensors (not shown), which includes one or more sensor circuits. In some embodiments, one or more of these sensors are included in one or more standalone sensor devices 702, each of which is an electronic device that obtain reflectance intensity data at the wavelength the embedded sensors (implementing one or more sensor circuits 712) operate.

The electronic device 704 includes hardware 740 comprising a set of one or more processor(s) 742 (which are common off-the-shelf (COTS) processors or processor cores, or application-specific integrated-circuits (ASICs)) and physical network interfaces (Nis) 746, as well as non-transitory machine-readable storage media 748 having stored therein obfuscator software 750. The heterogenous sensor based reflectance intensity predictor 222 performs operations such as the ones in methods 500 or 600 and/or the ones discussed relating to FIGS. 1 to 4A-4C.

During operation, the one or more processors 742 may execute the heterogenous sensor based reflectance intensity predictor 222 to instantiate one or more sets of one or more obfuscator instances 764A-R. While one embodiment does not implement virtualization, alternative embodiments may use different forms of virtualization. For example, in one such alternative embodiment the virtualization layer 754 represents the kernel of an operating system (or a shim executing on a base operating system) that allows for the creation of multiple instances 762A-R called software containers that may each be used to execute one (or more) of the sets of predictor instances 764A-R; where the multiple software containers (also called virtualization engines, virtual private servers, or jails) are user spaces (typically a virtual memory space) that are separate from each other and separate from the kernel space in which the operating system is run; and where the set of applications running in a given user space, unless explicitly allowed, cannot access the memory of the other processes. In another such alternative embodiment the virtualization layer 754 represents a hypervisor (sometimes referred to as a virtual machine monitor (VMM)) or a hypervisor executing on top of a host operating system, and each of the sets of predictor instances 764A-R is run on top of a guest operating system within an instance 762A-R called a virtual machine (which may in some cases be considered a tightly isolated form of software container) that is run on top of the hypervisor—the guest operating system and application may not know they are running on a virtual machine as opposed to running on a “bare metal” host electronic device, or through para-virtualization the operating system and/or application may be aware of the presence of virtualization for optimization purposes. In yet other alternative embodiments, one, some, or all of the applications are implemented as unikernel(s), which can be generated by compiling directly with an application only a limited set of libraries (e.g., from a library operating system (LibOS) including drivers/libraries of OS services) that provide the particular OS services needed by the application. As a unikernel can be implemented to run directly on hardware 740, directly on a hypervisor (in which case the unikernel is sometimes described as running within a LibOS virtual machine), or in a software container, embodiments can be implemented fully with unikernels running directly on a hypervisor represented by virtualization layer 754, unikernels running within software containers represented by instances 762A-R, or as a combination of unikernels and the above-described techniques (e.g., unikernels and virtual machines both run directly on a hypervisor, unikernels and sets of applications that are run in different software containers).

A network interface (NI) may be physical or virtual. In the context of IP, an interface address is an IP address assigned to an NI, be it a physical NI or virtual NI. A virtual NI may be associated with a physical NI, with another virtual interface, or stand on its own (e.g., a loopback interface, a point-to-point protocol interface). A NI (physical or virtual) may be numbered (a NI with an IP address) or unnumbered (a NI without an IP address).

Note that while system 700 as shown in FIG. 7 includes one electronic device 704 to implement heterogenous sensor reflectance intensity predictor 222, some embodiments may split the implementation of the functional blocks of heterogenous sensor reflectance intensity predictor 222 into several electronic devices. For example, each of point cloud constructor 242, intensity pairing 244, and intensity prediction 246 within heterogenous sensor reflectance intensity predictor 222 may be implemented in an electronic device of system 700, or two of the functional bocks may be implemented in one electronic device while the remaining one be implemented in another electronic device.

Some of the embodiments contemplated herein above are described more fully with reference to the accompanying drawings. Other embodiments, however, are contained within the scope of the subject matter disclosed herein, the disclosed subject matter should not be construed as limited to only the embodiments set forth herein; rather, these embodiments are provided by way of example to convey the scope of the subject matter to those skilled in the art.

### Terms

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features, and advantages of the enclosed embodiments will be apparent from the following description.

References in the specification to “one embodiment,” “an embodiment,” “an example embodiment,” and so forth, indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The description and claims may use the terms “coupled” and “connected,” along with their derivatives. These terms are not intended as synonyms for each other. “Coupled” is used to indicate that two or more elements, which may or may not be in direct physical or electrical contact with each other, co-operate or interact with each other. “Connected” is used to indicate the establishment of wireless or wireline communication between two or more elements that are coupled with each other. A “set,” as used herein, refers to any positive whole number of items including one item.

An electronic device stores and transmits (internally and/or with other electronic devices over a network) code (which is composed of software instructions and which is sometimes referred to as a computer program code or a computer program) and/or data using machine-readable media (also called computer-readable media), such as machine-readable storage media (e.g., magnetic disks, optical disks, solid state drives, read only memory (ROM), flash memory devices, phase change memory) and machine-readable transmission media (also called a carrier) (e.g., electrical, optical, radio, acoustical, or other form of propagated signals—such as carrier waves, infrared signals). Thus, an electronic device (e.g., a computer) includes hardware and software, such as a set of one or more processors (e.g., of which a processor is a microprocessor, controller, microcontroller, central processing unit, digital signal processor, application specific integrated circuit (ASIC), field programmable gate array (FPGA), other electronic circuitry, or a combination of one or more of the preceding) coupled to one or more machine-readable storage media to store code for execution on the set of processors and/or to store data. For instance, an electronic device may include non-volatile memory containing the code since the non-volatile memory can persist code/data even when the electronic device is turned off (when power is removed). When the electronic device is turned on, that part of the code that is to be executed by the processor(s) of the electronic device is typically copied from the slower non-volatile memory into volatile memory (e.g., dynamic random-access memory (DRAM), static random-access memory (SRAM)) of the electronic device. Typical electronic devices also include a set of one or more physical network interface(s) (NI(s)) to establish network connections (to transmit and/or receive code and/or data using propagating signals) with other electronic devices. For example, the set of physical NIs (or the set of physical NI(s) in combination with the set of processors executing code) may perform any formatting, coding, or translating to allow the electronic device to send and receive data whether over a wired and/or a wireless connection. In some embodiments, a physical NI may comprise radio circuitry capable of (1) receiving data from other electronic devices over a wireless connection and/or (2) sending data out to other devices through a wireless connection. This radio circuitry may include transmitter(s), receiver(s), and/or transceiver(s) suitable for radio frequency communication. The radio circuitry may convert digital data into a radio signal having the proper parameters (e.g., frequency, timing, channel, bandwidth, and so forth). The radio signal may then be transmitted through antennas to the appropriate recipient(s). In some embodiments, the set of physical NI(s) may comprise network interface controller(s) (NICs), also known as a network interface card, network adapter, or local area network (LAN) adapter. The NIC(s) may facilitate in connecting the electronic device to other electronic devices allowing them to communicate with wire through plugging in a cable to a physical port connected to an NIC. One or more parts of an embodiment of the invention may be implemented using different combinations of software, firmware, and/or hardware.

A wireless communication network (or “wireless network,” and the two terms are used interchangeably) is a network of electronic devices communicating using radio waves (electromagnetic waves within the frequencies 30 KHz-300 GHz). The wireless communications may follow wireless communication standards, such as new radio (NR), LTE-Advanced (LTE-A), LTE, wideband code division multiple access (WCDMA), High-Speed Packet Access (HSPA). Furthermore, the communications between the electronic devices such as network devices and terminal devices in the wireless communication network may be performed according to any suitable generation communication protocols, including, but not limited to, the first generation (1G), the second generation (2G), 2.5G, 2.75G, the third generation (3G), the fourth generation (4G), 4.5G, the fifth generation (5G) communication protocols, and/or any other protocols either currently known or to be developed in the future. While LTE and NR are used as examples to describe embodiments of the invention, the invention may apply to other wireless communication networks, including LTE operating in unlicensed spectrums, Multefire systems, and IEEE 802.11 systems

A network node or node (also referred to as a network device (ND), and these terms are used interchangeably in this disclosure) is an electronic device in a wireless communication network via which a wireless device accesses the network and receives services therefrom. One type of network node may refer to a base station (BS) or an access point (AP), for example, a node B (NodeB or NB), an evolved NodeB (eNodeB or eNB), a next generation node B (gNB), a remote radio unit (RRU), a radio header (RH), a remote radio head (RRH), a relay, and a low power node such as a femtocell and a picocell.

A wireless device (WD) may access a wireless communication network and receive services from the wireless communication network through a network node. A wireless device may also be referred to as a terminal device, and the two terms are used interchangeably in this disclosure. A wireless device may be a subscriber station (SS), a portable subscriber Station, a mobile station (MS), an access terminal (AT), or other end user devices. An end user device (also referred to as end device, and the two terms are used interchangeably) may be one of a mobile phone, a cellular phone, a smart phone, a tablet, a wearable device, a personal digital assistant (PDA), a portable computer, an image capture terminal device (e.g., a digital camera), a gaming terminal device, a music storage and playback appliance, a smart appliance, a vehicle-mounted wireless terminal device, a smart speaker, and an Internet of Things (IoT) device. Terminal devices may be coupled (e.g., through customer premise equipment coupled to an access network (wired or wirelessly)) to edge NDs, which are coupled (e.g., through one or more core NDs) to other edge NDs, which are coupled to electronic devices acting as servers.

The electronic device implementing embodiments of the invention may be a wireless device, a network node, or another electronic device that operates in a wireline network.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

The term unit may have conventional meaning in the field of electronics, electrical devices, and/or electronic devices and may include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

1. A method to be performed by an electronic device to predict reflectance intensity, the method comprising:
pairing a first tuple with a second tuple based on a same point or adjacent points in a point cloud for a physical region that are represented by the first and second tuples, the first tuple including a first reflectance intensity and a first wavelength through which the first reflectance intensity is obtained and the second tuple including a second reflectance intensity and a second wavelength through which the second reflectance intensity is obtained;
generating a prediction function for the point cloud to perform reflectance intensity prediction based on the first and second tuples, the prediction function being trained using reflectance intensity spectral distributions of a plurality of materials; and
determining a third reflectance intensity based on an input of a third wavelength to the prediction function.

2. The method of claim 1, wherein the first tuple is from data collected by a first sensor that operates at the first wavelength and the second tuple is from data collected by a second sensor that operates at the second wavelength, wherein the point cloud for the physical region is generated based on a plurality of point clouds that include a first point cloud generated from the data collected by the first sensor and a second point cloud generated from the data collected by the second sensor.

3. The method of claim 1, wherein each of the first and second tuples further includes one three-dimensional coordinates of the same or adjacent points, and a value based on one sensor through which corresponding data is collected.

4. The method of claim 1, wherein pairing the first tuple with the second tuple comprises selecting the second tuple from a plurality of tuples using a machine learning model, each tuple of the plurality of tuples including one reflectance intensity and one wavelength through which the one reflectance intensity is obtained.

5. The method of claim 4, wherein the second tuple is selecting based on the machine learning model identifying a plurality of nearest points in the point cloud to a corresponding point represented by the first tuple, and the second tuple representing one of the plurality of nearest points.

6. The method of claim 4, wherein the second tuple is selected based on the machine learning model identifying a plurality of points that form a first convex hull closest to a second convex hull containing a corresponding point represented by the first tuple, and the second tuple representing one of the plurality of points.

7. The method of claim 4, wherein the second tuple is selected based on the machine learning model identifying a plurality of points that are determined to correspond to a same material as the first tuple, and the second tuple representing one of the plurality of points.

8. The method of claim 4, wherein the second tuple is selected based on the machine learning model identifying a plurality of points that form a first convex hull that intersects with a second convex hull including a corresponding point represented by the first tuple, the second tuple representing one of the plurality of points, and wherein the first and second convex hulls are formed through segmentation.

9. The method of claim 4, wherein the second tuple is selected based on the machine learning model identifying a plurality of points that form a first convex hull that intersects with a second convex hull including a corresponding point represented by the first tuple, the second tuple representing one of the plurality of points, and wherein the first and second convex hulls are formed by a first and second sensor operating at different wavelengths.

10. The method of claim 1, further comprising:
providing the determined third reflectance intensity as input to a process for localization with respect to the physical region.

11. The method of claim 1, wherein the same or adjacent points represented by the first and second tuples corresponds a same point position in the point cloud, and the first and second wavelengths are different wavelengths.

12. The method of claim 1, wherein the same or adjacent points represented by the first and second tuples are adjacent points in the point cloud for the physical region and the same or adjacent points corresponding to a same material in the physical region.

13. An electronic device, comprising:
a processor and non-transitory machine-readable storage medium that provides instructions that, when executed by the processor, are capable of causing the electronic device to perform:
pairing a first tuple with a second tuple based on same or adjacent points in a point cloud for a physical region that are represented by the first and second tuples, the first tuple including a first reflectance intensity and a first wavelength through which the first reflectance intensity is obtained and the second tuple including a second reflectance intensity and a second wavelength through which the second reflectance intensity is obtained;
generating a prediction function for the point cloud to perform reflectance intensity prediction based on the first and second tuples, the prediction function being trained using reflectance intensity spectral distributions of a plurality of materials; and
determining a third reflectance intensity based on an input of a third wavelength to the prediction function.

14. The electronic device of claim 13, wherein the first tuple is from data collected by a first sensor that operates at the first wavelength and the second tuple is from data collected by a second sensor that operates at the second wavelength, wherein the point cloud for the physical region is generated based on a plurality of point clouds that include a first point cloud generated from the data collected by the first sensor and a second point cloud generated from the data collected by the second sensor.

15. The electronic device of claim 13, wherein each of the first and second tuples further includes one three-dimensional coordinates of the same or adjacent points, and a value based on one sensor through which corresponding data is collected.

16. The electronic device of claim 13, wherein pairing the first tuple with the second tuple comprises selecting the second tuple from a plurality of tuples using a machine learning model, each tuple of the plurality of tuples including one reflectance intensity and one wavelength through which the one reflectance intensity is obtained.

17. (canceled)

18. (canceled)

19. (canceled)

20. (canceled)

21. (canceled)

22. The electronic device of claim 13, wherein the instructions, when executed by the processor, are capable of causing the electronic device to perform further comprising:
providing the determined third reflectance intensity as input to a process for localization with respect to the physical region.

23. (canceled)

24. (canceled)

25. A non-transitory machine-readable storage medium that provides instructions that, when executed by a processor, are capable of causing an electronic device to perform:
pairing a first tuple with a second tuple based on a same point or adjacent points in a point cloud for a physical region that are represented by the first and second tuples, the first tuple including a first reflectance intensity and a first wavelength through which the first reflectance intensity is obtained and the second tuple including a second reflectance intensity and a second wavelength through which the second reflectance intensity is obtained;
generating a prediction function for the point cloud to perform reflectance intensity prediction based on the first and second tuples, the prediction function being trained using reflectance intensity spectral distributions of a plurality of materials; and
determining a third reflectance intensity based on an input of a third wavelength to the prediction function.

26. (canceled)

27. (canceled)

28. The non-transitory machine-readable storage medium of claim 25, wherein pairing the first tuple with the second tuple comprises selecting the second tuple from a plurality of tuples using a machine learning model, each tuple of the plurality of tuples including one reflectance intensity and one wavelength through which the one reflectance intensity is obtained.

29. The non-transitory machine-readable storage medium of claim 28, wherein the second tuple is selecting based on the machine learning model identifying a plurality of nearest points in the point cloud to a corresponding point represented by the first tuple, and the second tuple representing one of the plurality of nearest points.
